(19) United States
(12) Patent Application Publication
(10) Pub. No.: US 2025/0292443 A1
(43) Pub. Date: Sep. 18, 2025

(54) MULTI-COMPONENT LATENT PYRAMID SPACE FOR GENERATIVE MODELS

(71) Applicant: ADOBE INC., SAN JOSE, CA (US)

(72) Inventors: Jianming Zhang, Cupertino, CA (US); Haitian Zheng, San Jose, CA (US); Zhifei Zhang, San Jose, CA (US); Zhe Lin, Clyde Hill, WA (US)

(21) Appl. No.: 18/607,813

(22) Filed: Mar. 18, 2024

(51) Int. Cl. G06T 11/00; G06T 9/00

(52) U.S. Cl. CPC G06T 11/00; G06T 9/00

(57) ABSTRACT

A method, apparatus, non-transitory computer readable medium, apparatus, and system for image processing include obtaining a text prompt; generating, using a generator of an image generation model, a feature embedding based on the text prompt, wherein the feature embedding includes a first set of channels that encodes a first value of an image characteristic and a second set of channels that encodes a residual between the first value of the image characteristic and a second value of the image characteristic; and generating, using a decoder of the image generation model, a synthetic image corresponding to the second value of the image characteristic based on the feature embedding.

### BACKGROUND

The following relates generally to image processing, and more specifically to image processing using generative machine learning models. Image processing refers to the digital creation and manipulation of images. Generative machine learning is used to create new data that closely resembles an existing dataset, commonly employed in tasks like image processing and text generation. For example, image generation models can create realistic images by analyzing and imitating complex patterns from training data in a latent space. In some cases, generative models can operate within a well-defined, compact latent space (rather than in pixel space). The quality of data representation, integral to the quality of the latent space, is essential for effectively restoring images from latent codes and for the overall success of generative model training.

### SUMMARY

Embodiments of the present disclosure provide a multi-stage method for generating synthetic images using an image generation model. The process starts by obtaining a text prompt, followed by using a generator of the image generation model to generate a feature embedding containing multiple distinct sets of channels, each set corresponding to a different stage of the process and derived from the text prompt. A decoder, trained through multiple stages, then uses the feature embedding to generate a synthetic image. Each stage involves training with encoders that output different sets of channels. The trained decoder, taking in the cumulatively combined feature embedding corresponding to each stage, outputs an image that is a representation of the original text prompt. This multi-stage training method increases the efficiency of successfully training an image generation model and improves the quality of the synthetic images.

A method, apparatus, and non-transitory computer readable medium for image processing are described. One or more aspects of the method, apparatus, and non-transitory computer readable medium include obtaining a text prompt, generating a feature embedding based on the text prompt, and generating a synthetic image corresponding to a second image characteristic based on the feature embedding. The feature embedding includes a first set of channels that encodes a first value of an image characteristic and a second set of channels that encodes a residual between the first value of the image characteristic and a second value of the image characteristic.

A method, apparatus, and non-transitory computer readable medium for image processing are described. One or more aspects of the method, apparatus, and non-transitory computer readable medium include obtaining a training set including a first image and a second image; encoding, using a first encoder, the first image to obtain a first encoder output; training an image generation model in a first stage based on the first encoder output; encoding, using a second encoder, the second image to obtain a second encoder output; and training the image generation model in the second stage based on the second encoder output.

An apparatus and method for image processing are described. One or more aspects of the apparatus and method include at least one processor; at least one memory storing instruction executable by the at least one processor, and an image generation model comprising instruction stored in the at least one memory and trained to generate a synthetic image. The image generation model includes a generator and a decoder. The image generation model includes a generator and a decoder, wherein the generator is trained to generate a feature embedding based on a text prompt. The feature embedding includes a first set of channels that encodes a first value of an image characteristic and a second set of channels that encodes a residual between the first value of the image characteristic and a second value of the image characteristic. The decoder is trained to generate synthetic images corresponding to a second image characteristic based on the feature embedding. The generator and the decoder are trained using a first encoder that outputs the first set of channels and a second encoder that outputs the second set of channels.

### BRIEF DESCRIPTION OF THE DRAWINGS

FIG. 1 shows an example of an image processing system according to aspects of the present disclosure.

FIG. 2 shows an example of an image generation application according to aspects of the present disclosure.

FIG. 3 shows an example of an example of generating a synthetic image according to aspects of the present disclosure.

FIG. 4 shows an example of a method for image processing according to aspects of the present disclosure.

FIG. 5 shows an example of an image processing apparatus according to aspects of the present disclosure.

FIG. 6 shows an example of a U-Net according to aspects of the present disclosure.

FIG. 7 shows an example of a method for image processing according to aspects of the present disclosure.

FIG. 8 shows an example of training an image generation model according to aspects of the present disclosure.

FIG. 9 shows an example of training an image generation model according to aspects of the present disclosure.

FIG. 10 shows an example of a computing device according to aspects of the present disclosure.

### DETAILED DESCRIPTION

Recent developments in machine learning, particularly in latent image generation, have centered on improving the quality and efficiency of generated images. This technology is used in applications like automated content creation, design, and data visualization. These systems typically work within a compact latent space, a crucial factor in defining the fidelity and diversity of the generated images.

Traditional methods in latent image generation involve generating samples within a compact latent space, then decoding them into tangible formats like images or videos. However, these methods face a trade-off in the amount of information retained in the latent space, affecting the quality of data restoration and model training. For example, having more information encoded in the latent space can overwhelm the model, hindering effective training and learning. On the other hand, having less information encoded in the latent space can result in loss of detail and quality in the generated images.

Embodiments of the present disclosure provide systems and methods that increase the accuracy and quality of synthetic images. Embodiments also increase the training efficiency of image generation models. The systems and methods include dividing a latent space into multiple components based on the training process, with each component encoding information in distinct channels. By implementing a multi-stage learning approach within the latent space, each component is designed to capture different levels of information in the distinct channels, enhancing the overall efficacy and stability of the training process. Some embodiments of the present disclosure provide a progressive, multi-stage training pipeline by introducing new encoders and decoders at each stage. These stages work in tandem, with each new encoder designed to complement and build upon the work of the previous encoders, leading to a more refined and accurate image reconstruction.

### Image Processing Method

Accordingly, the present disclosure includes the following aspects. In some aspects, a method for image processing is described. One or more aspects of the method include obtaining a text prompt; generating, using a generator of an image generation model, a feature embedding including a first set of channels and a second set of channels based on the text prompt; and generating, using a decoder of the image generation model, a synthetic image based on the feature embedding, wherein the generator and the decoder of the image generation model are trained using a first encoder that outputs the first set of channels and a second encoder that outputs the second set of channels.

In some aspects, the generator and the decoder of the image generation model are trained using a third encoder that outputs a third set of channels. Some examples of the method, apparatus, and non-transitory computer readable medium further include generating the feature embedding comprises performing a reverse latent diffusion process.

In some aspects, the first set of channels encodes a different modality from the second set of channels. In some aspects, the first set of channels encodes a low-resolution version of an image and the second set of channels encoders a difference between the image and the low-resolution version of the image. In some aspects, the image characteristic comprises spatial resolution of the image, the first value of the image characteristic comprises a low spatial resolution, and the second value of the image characteristic comprises a high spatial resolution that is higher than the low spatial resolution.

Some examples of the method, apparatus, and non-transitory computer readable medium further include generating, using the image generation model, a video including a plurality of frames based on the feature embedding, wherein the first set of channels encodes a first set of frames of the plurality of frames, and the second set of channels encodes a second set of frames of the plurality of frames. For example, in some cases the synthetic image comprises a frame of a video, the image characteristic comprises temporal resolution of the video, the first value of the image characteristic comprises a low temporal resolution and the second value of the image characteristic comprises a high temporal resolution that is higher than the first temporal resolution.

In some aspects, the image generation model is trained in a first stage using the first encoder and a second stage using the first encoder and the second encoder. In some aspects, the synthetic image includes an element from the text prompt based on the feature embedding.

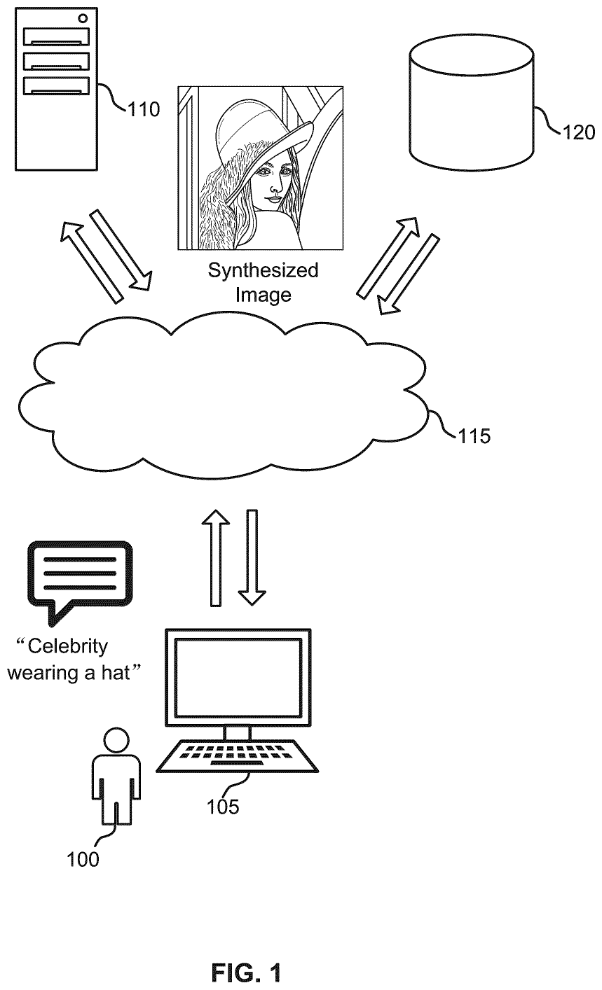

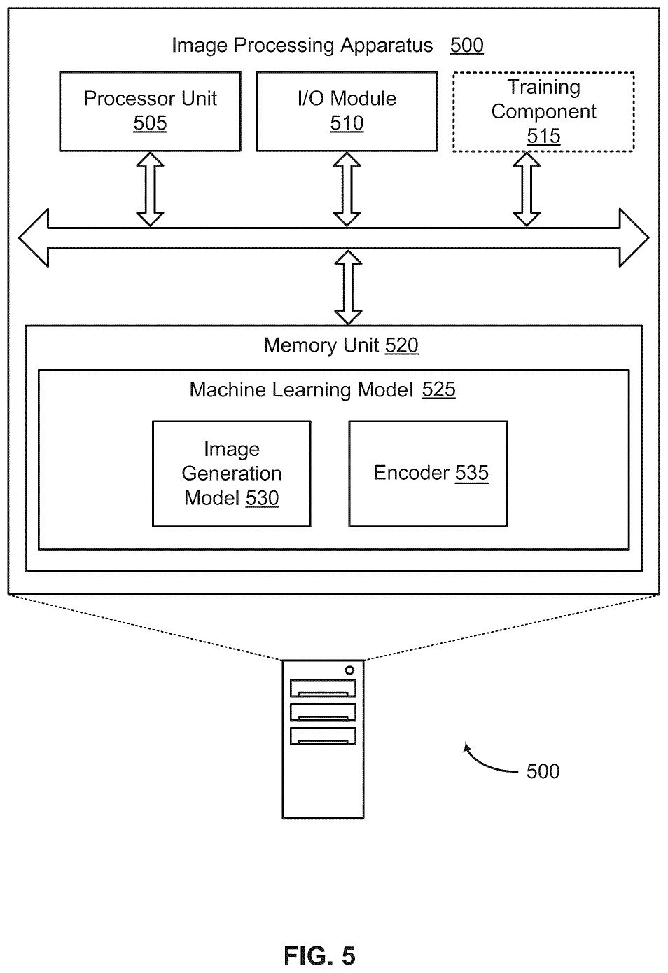

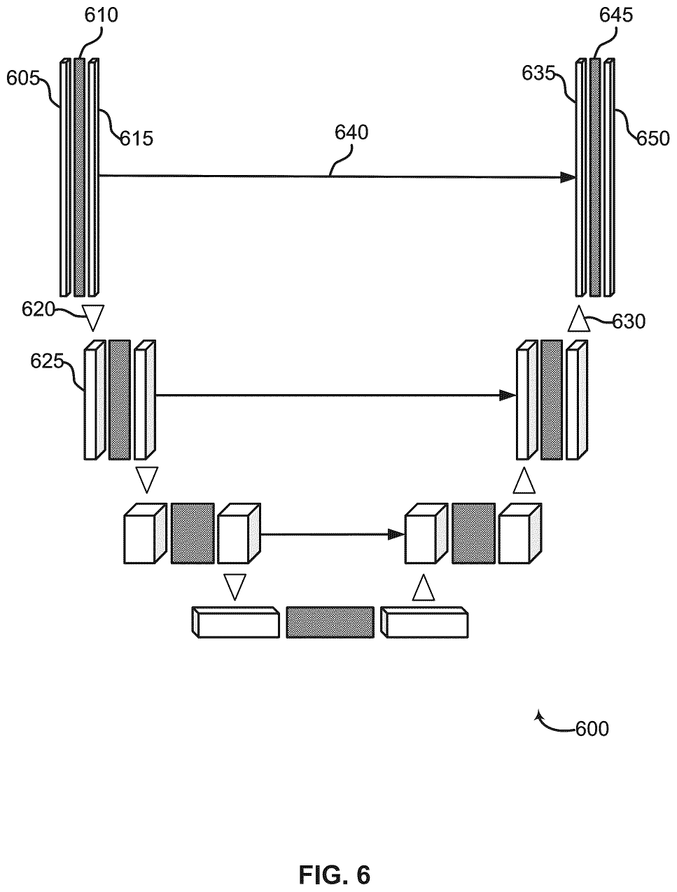

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 5-6.

In the example shown in FIG. 1, the user provides a text prompt, such as “celebrity wearing a hat”, to the image processing apparatus 110, e.g., via user device 105 and cloud 115. Image processing apparatus 110 then processes this text prompt to capture the essence of the request. For example, image processing apparatus 110 employs multiple encoders, each configured to encode specific types of information into distinct channels. For example, these encoders analyze the text prompt “celebrity wearing a hat,” with each focusing on different aspects such as the celebrity's features, attire details, and overall style. The encoded information is then fed into a generator of the apparatus. This generator converts the structured format provided by the encoders into a comprehensive feature embedding suitable for image generation. This embedding includes multiple sets of channels, each corresponding to a different stage of processing and derived from the text prompt. The trained decoder then uses this feature embedding to generate a synthetic image that visually represents the concept of a “celebrity wearing a hat.” The final image is a representation of the text prompt, demonstrating the apparatus's capability to transform textual descriptions into high-quality visual content. The resultant output image is then returned to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

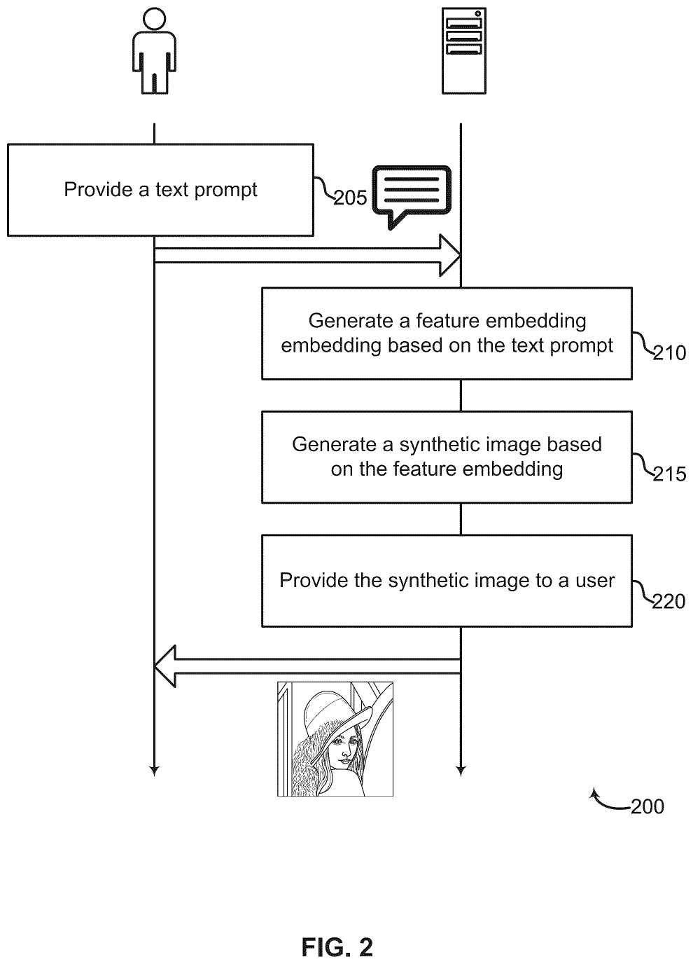

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIG. 2.

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 5-6. Further detail regarding the operation of image processing apparatus 110 is provided with reference to FIGS. 5-6.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image generation application 200 according to aspects of the present disclosure. The image generation application is an example of, or includes aspects of, the corresponding element described with reference to FIGS. 5-8.

At operation 205, the user provides a text prompt. In some examples, the text prompt may be descriptive. In some cases, the operations of this step are performed by a user as described with reference to FIG. 1. For example, in operation 205, the user begins the image generation process by inputting a text prompt such as “celebrity wearing a hat”. This prompt indicates one or more specific subjects and attributes to be included in the generated image.

At operation 210, the system generates a feature embedding based on the text prompt. In some cases, the operations of this step are performed by an image processing apparatus as described with reference to FIGS. 5-8. For example, at operation 210, the system processes the text prompt “celebrity wearing a hat” to create a feature embedding. This embedding involves mapping the descriptive elements of the prompt to specific features, such as the appearance of the celebrity and the style of the hat, to a latent space of a machine learning model in the system.

At operation 215, the system generates a synthetic image based on the feature embedding. In some cases, the operations of this step are performed by an image processing apparatus as described with reference to FIGS. 5-8. For example, at operation 215, the system uses the feature embedding to synthesize an image that visually represents the text prompt. The system ensures that the key elements, like the celebrity's likeness and the hat's style, are accurately portrayed in the synthetic image, effectively translating the textual description into a visual format.

At operation 220, the system provides the synthetic image to the user. In some cases, the operations of this step are performed by an image processing apparatus as described with reference to FIGS. 5-8. For example, at operation 220, the system presents the generated synthetic image to the user. This image is a visual representation of the prompt “celebrity wearing a hat,” showcasing the system's ability to accurately interpret and visualize text descriptions. The user can then review the image to assess its adherence to the prompt and its overall quality. If needed, the user has the option to modify the prompt or adjust parameters for generating a different synthetic image.

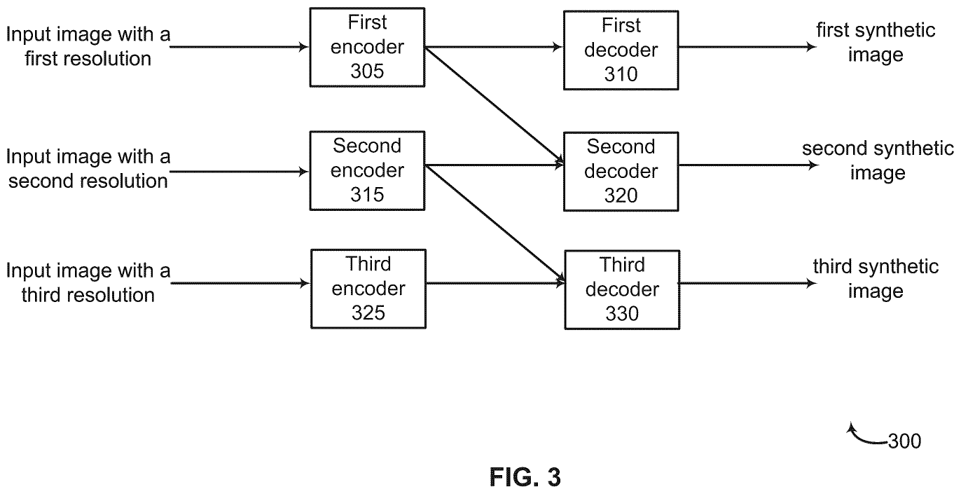

FIG. 3 shows an example of a method 300 for generating a synthetic image according to aspects of the present disclosure. This method for generating a synthetic image is an example of, or includes aspects of, the corresponding element described with reference to FIGS. 2, 5-6, and 10.

According to some embodiments, training an image generation model involves a progressive image generation process employing a modification of the Laplacian Image Pyramid. In this process, each stage involves a new encoder-decoder pair, with each encoder processing an increasingly higher-resolution image. The decoders reconstruct images using combined outputs from all encoders, with prior stage encoders remaining static. Post-training, a collection of encoders represents various levels of image detail, and the final stage's decoder synthesizes the complete image, applying this methodology across diverse data domains including video and 3D voxels.

Referring to FIG. 3, the first stage involves first encoder 305 processing an input image with a first resolution. The output of encoder 305 is used by first decoder 310 to generate a first synthetic image. For example, In the first stage, first encoder 305 processes a low-resolution input image. The first decoder 310 then uses the encoder's output to generate a basic version of the synthetic image. This stage establishes the foundational structure of the image.

In the second stage, the second encoder 315 takes the input image at a second resolution. It combines its output with that of the first encoder 305, and this combined output is used by second decoder 320 to create a second synthetic image. For example, in the second stage, second encoder 315 takes as input a higher-resolution version of the input image. By integrating the output of the first encoder 305, the second decoder 320 enhances the image, adding more detail and refining the initial structure created in the first stage.

The third stage engages third encoder 325 with the input image at a third, higher resolution. The outputs of encoders 305, 315, and 325 are combined and provided to third decoder 330, which synthesizes a final, detailed synthetic image. For example, in the third stage, third encoder 325 takes as input an even higher resolution image. The combined outputs from all previous encoders are used by third decoder 330 to produce the final synthetic image, incorporating the highest level of detail and resolution, thus completing the progressive refinement process.

However, embodiments of the present disclosure are not limited thereto. This framework is not limited to three stages and can be extended or reduced in number. According to certain embodiments, with two stages, this method enhances training efficiency. In some cases, each stage incrementally adds detail and improves image resolution, leading to a high-quality synthetic image.

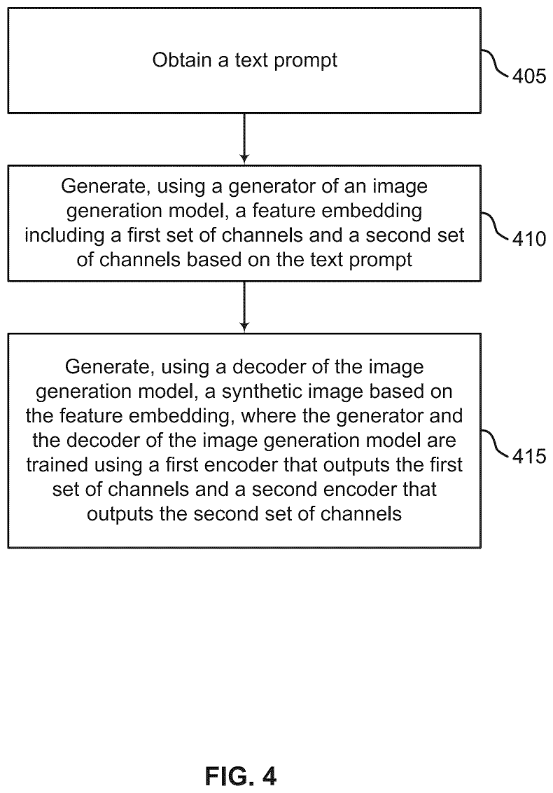

FIG. 4 shows an example of a method for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains a text prompt. In some cases, the operations of this step refer to, or may be performed by, an encoder as described with reference to FIG. 5. For example, obtaining a text prompt may involve an interactive interface where users input descriptive text, which is then processed by the system.

For example, in operation 405, obtaining a text prompt may include a scenario where a user inputs a description like “celebrity wearing a hat” into the system. This prompt is then analyzed by the first encoder. For example, the first encoder might focus on general features of the image such as the outline of a celebrity and a hat. A subsequent encoder could then specialize in more detailed aspects, like the textures and colors of the hat or the specific features of the celebrity.

At operation 410, the system generates, using an encoder of an image generation model, a feature embedding based on the text prompt, wherein the feature embedding includes a first set of channels that encodes a first value of an image characteristic and a second set of channels that encodes a residual between the first value of the image characteristic and a second value of the image characteristic. In some cases, the operations of this step refer to, or may be performed by, a generator as described with reference to FIG. 5. The image characteristic can represent attributes of an output image or video include spatial resolution, temporal resolution, or other modalities such as image layout, segmentation, and pixel representation.

For example, the embedding space may include multiple channels representing different resolutions (spatial resolution), frame rates (temporal resolution), or modalities. If the channels represent different resolutions, a first channel can encode a lower resolution and a second channel can encode a residual between the lower resolution and a higher resolution.

In the spatial resolution example, the first set of channels may be generated using parameters trained before parameters used to generate the second set of channels. In the first training phase, the model is trained to generate a low resolution, and in a second training phase additional parameters are added to encode a residual between the low resolution and a higher resolution. In some cases, the residual is obtained by generating an estimate of the high resolution based on the lower resolution and finding a difference between the estimate and a target at the higher resolution.

A similar process may be used to train a video generation model. That is, the model may be trained to generate videos with a low frame rate using a first set of channels, and then additional channels can be added to generate videos with a higher frame rate based on a residual between the low frame rate and the higher frame rate. Thus, second channels representing a higher frame rate (i.e., a high temporal resolution) can represent additional frames of an output video that are not represented by the first set of channels.

Accordingly, the first value may encode a lower resolution or a lower frame rate, with less detailed latent representation or a simplified image segmentation layout that outlines major components of the image based on the text prompt. The second value may encode a higher resolution or a higher frame rate, with increased detail and clarity. For example, the first value and the second value of an image characteristic may represent different image modalities such as a latent representation, an image segmentation layout, and a pixel representation. For example, the image characteristic with the first value may correspond to a latent representation. The image characteristic with the second value may correspond to a pixel representation that provides intricate details such as rich texture and color or a more complex image segmentation layout that includes finer elements of the scene.

For example, at operation 410, the system uses the generator of the image generation model to generate a feature embedding based on the text prompt “celebrity wearing a hat.” This feature embedding is a vector in a vector space, encapsulates information from the input in a structured, numerical format. For example, the embedding includes multiple sets of channels, each corresponding to different stages of processing. The first set of channels are based on the first encoder's output. For example, the first set of channels of the feature embedding may include information of the basic shapes and outlines of a synthetic, forming the foundational structure of the synthetic image. The second set of channels are based on the second encoder's output. For example, the second set of channels of the feature embedding may introduce information of more intricate details such as textures and specific characteristics of the subject, such as the facial features of the celebrity.

In some cases, there are additional stages. For example, an additional third stage may be involved, and a third set of channels is incorporated into the feature embedding. The third set of channels may be used to capture even finer details and subtleties, further refining the image and making it more realistic based on the text prompt. In one example, the third set of channels may focus on aspects such as the overall lighting and shadow effects of the synthetic image. In another example, the third set of channels may focus on non-facial features such as the hat's design. The generator, by integrating these multi-stage channels, constructs a comprehensive and multi-dimensional feature embedding. This detailed and layered approach in the feature embedding process generates the final synthetic image that not only captures the basic concept but also embodies the depth and complexity intended in the text prompt.

At operation 415, the system generates, using a decoder of the image generation model, a synthetic image corresponding to a second image characteristic based on the feature embedding. In some cases, the operations of this step refer to, or may be performed by, a decoder as described with reference to FIG. 5.

For example, at operation 415, the system utilizes the decoder of the image generation model to generate a synthetic image corresponding to a second image characteristic, based on the feature embedding. This process may involve reverse diffusion. Reverse diffusion is a method whereby the decoder progressively transforms a less defined, abstract representation into a precise, detailed image. This reverse diffusion reverses a diffusion process of incrementally adding noise to an image to generate diverse training datasets. Through reverse diffusion, the decoder may produce a coherent and detailed synthetic image that aligns with the second image characteristic.

For example, the decoder takes as input the combined feature embedding provided by the generator. The decoder decodes the combined feature embedding by interpreting the multiple sets of channels, e.g., the basic outlines from the first encoder and the more detailed features from the second encoder, and additional sets if further stages are involved. In some examples, the first image character is the basic outlines, and the second image character is the more detailed features. This process further involves iteratively refining the image, where each step brings the synthetic image closer to a realistic representation of the text prompt “celebrity wearing a hat.”

In this reverse diffusion process, the decoder effectively reconstructs the image from a high-level abstract representation to a detailed and accurate visual output. The decoder also works towards coherently integrating different aspects of information, from basic shapes to intricate textures and lighting effects. Through this reverse diffusion, the decoder generates the final synthetic image that aligns with the initial concept in the text prompt while embedding the nuanced details, leading to a result that is both visually realistic and adhering to the intended description.

### Image Generation Apparatus

An apparatus for image processing is described. One or more aspects of the apparatus include at least one processor; at least one memory storing instruction executable by the at least one processor; and an image generation model comprising instruction stored in the at least one memory and trained to generate a synthetic image, where the image generation model includes a generator and a decoder, wherein the generator is trained to generate a feature embedding including a first set of channels and a second set of channels wherein the decoder is trained to generate a synthetic image based on the feature embedding, and wherein the generator and the decoder are trained using a first encoder that outputs the first set of channels and a second encoder that outputs the second set of channels.

In some aspects, the generator comprises a latent diffusion model. In some aspects, the decoder is trained using a variational autoencoder (VAE) model based on an output of the first encoder and the second encoder.

In some aspects, the decoder is trained using the VAE model based on an output of a third encoder that outputs a third set of channels. In some aspects, the first encoder is trained using a VAE model based on an output of a first encoder that takes the first set of channels as input.

FIG. 5 shows an example of an image generation apparatus 500 according to aspects of the present disclosure. Image generation apparatus 500 is an example of, or includes aspects of, the corresponding element described with reference to FIG. 1. In one aspect, image generation apparatus 500 includes processor unit 505, I/O module 510, training component 515, memory unit 520, machine learning model 525 including image generation model 530 and encoder 535.

Processor unit 505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 505 is configured to operate a memory array using a memory controller. In other cases, a memory controller is integrated into processor unit 505. In some cases, processor unit 505 is configured to execute computer-readable instructions stored in memory unit 520 to perform various functions. In some aspects, processor unit 505 includes special purpose components for modem processing, baseband processing, digital signal processing, or transmission processing. According to some aspects, processor unit 505 comprises one or more processors described with reference to FIG. 15.

Memory unit 520 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 505 to perform various functions described herein.

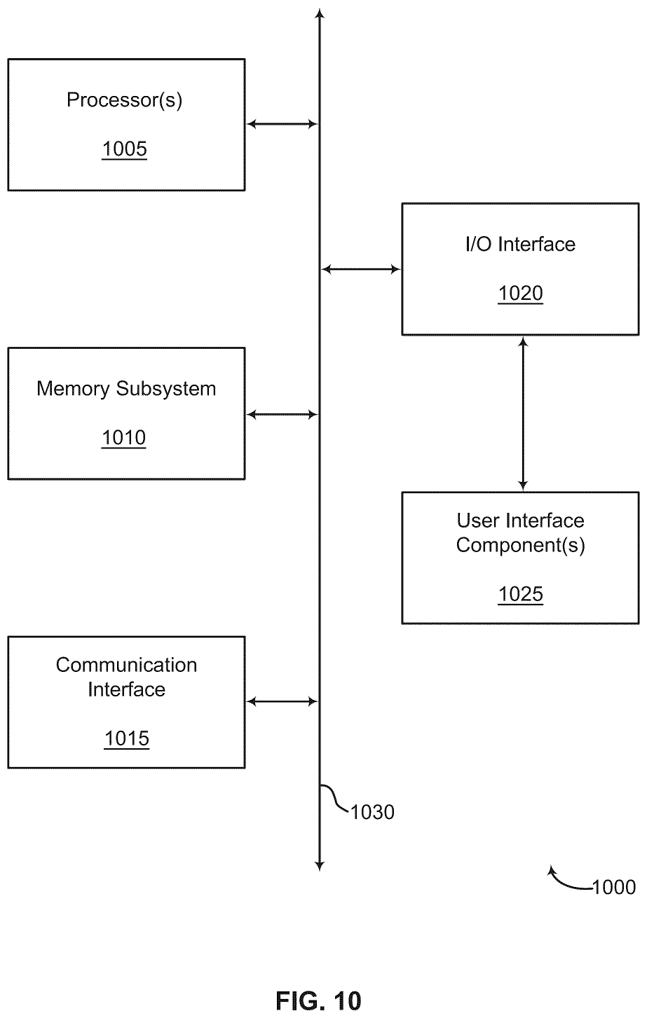

In some cases, memory unit 520 includes a basic input/output system (BIOS) that controls basic hardware or software operations, such as an interaction with peripheral components or devices. In some cases, memory unit 520 includes a memory controller that operates memory cells of memory unit 520. For example, the memory controller may include a row decoder, column decoder, or both. In some cases, memory cells within memory unit 520 store information in the form of a logical state. According to some aspects, memory unit 520 comprises the memory subsystem described with reference to FIG. 10.

According to some aspects, image generation apparatus 500 uses one or more processors of processor unit 505 to execute instructions stored in memory unit 520 to perform functions described herein. For example, in some cases, the image generation apparatus 500 obtains a prompt. In some cases, the prompt comprises a text prompt.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, encoder 535 obtains a text prompt. In some aspects, the first set of channels encodes a different modality from the second set of channels. In some aspects, the first set of channels encodes a low-resolution version of an image, and the second set of channels encodes a difference between the image and the low-resolution version of the image. That is, in some cases the image characteristic comprises spatial resolution of the image, the first value of the image characteristic comprises a low spatial resolution, and the second value of the image characteristic comprises a high spatial resolution that is higher than the low spatial resolution.

According to some aspects, encoder 535 includes a first encoder, a second encoder, and a third encoder. In some examples, machine learning model 525 encodes, using the first encoder, the first image to obtain a first encoder output. In some examples, machine learning model 525, using a second encoder, the second image to obtain a second encoder output. In some aspects, the second encoder output has the same resolution as the first encoder output and more channels than the first encoder output. In some examples, machine learning model 525 encodes the second image includes involves encoding, using the first encoder, the second image to obtain an intermediate encoder output, where the second encoder output is based on the intermediate encoder output. In some examples, machine learning model 525, using a third encoder, a third image to obtain a third encoder output.

In some aspects, the first encoder is trained using a VAE model based on an output of a first encoder that takes the first set of channels as input. According to some aspects, image generation model 530 generates, using a generator of image generation model 530, a feature embedding including a first set of channels and a second set of channels based on the text prompt. In some examples, image generation model 530 generates the feature embedding includes performing a reverse latent diffusion process.

In some aspects, the image generation model 530 includes a latent diffusion model. According to some aspects, decoder generates, using a decoder of the image generation model, a synthetic image based on the feature embedding, where the image generation model 530 and the decoder of the image generation model are trained using a first encoder that outputs the first set of channels and a second encoder that outputs the second set of channels.

In some aspects, the decoder is trained using a variational autoencoder (VAE) model based on an output of the first encoder and the second encoder. In some aspects, the decoder is trained using the VAE model based on an output of a third encoder that outputs a third set of channels. In some aspects, the image generation model is trained in a first stage using the first encoder and a second stage using the first encoder and the second encoder.

According to some aspects, training component 515 creates a training set including a first image and a second image. In some examples, training component 515 trains an image generation model in a first stage based on the first encoder output. In some examples, training component 515 trains the image generation model in the second stage based on the second encoder output. In some examples, training component 515 adds parameters to the image generation model after the first stage, where the parameters are trained in the second stage. In some aspects, the parameters are added to an input layer or an output layer of the image generation model. In some examples, training component 515 trains the image generation model on a third stage based on the third encoder output. In some examples, training component 515 trains the first encoder based on a first decoder. In some examples, training component 515 trains the second encoder based on the first encoder and a second decoder.

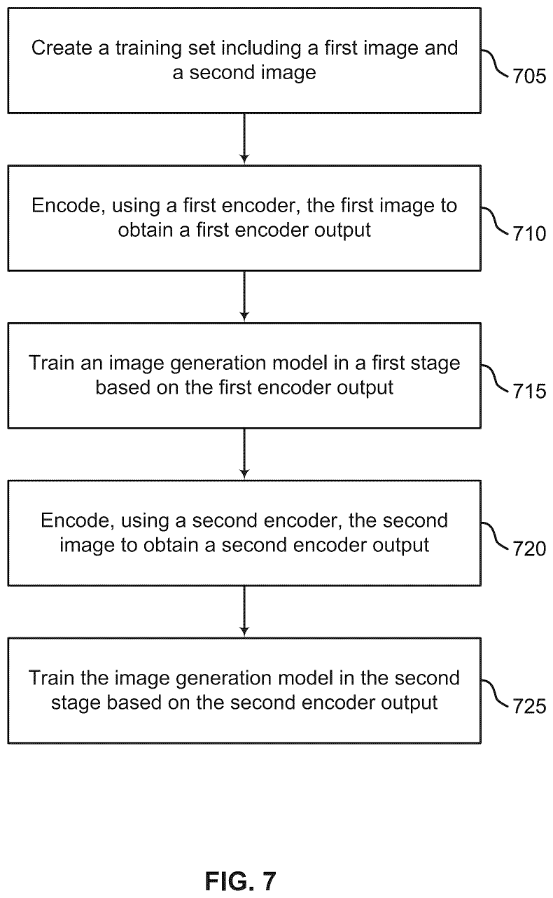

FIG. 6 shows an example of a U-Net according to aspects of the present disclosure. FIG. 6 is an example of, or includes aspects of, the corresponding element described with reference to FIGS. 2, 3, and 8-12. According to some aspects, a diffusion model comprises an ANN architecture known as a U-Net. In some cases, U-Net 600 implements reverse diffusion processes described with reference to FIG. 7.

According to some aspects, U-Net 600 receives input features 605, where input features 605 include an initial resolution and an initial number of channels, and processes input features 605 using an initial neural network layer 610 (e.g., a convolutional neural network layer) to produce intermediate features 615.

In some cases, intermediate features 615 are then down-sampled using a down-sampling layer 620 such that down-sampled features 625 have a resolution less than the initial resolution and a number of channels greater than the initial number of channels.

In some cases, this process is repeated multiple times, and then the process is reversed. For example, down-sampled features 625 are up-sampled using up-sampling process 630 to obtain up-sampled features 635. In some cases, up-sampled features 635 are combined with intermediate features 615 having the same resolution and number of channels via skip connection 640. In some cases, the combination of intermediate features 615 and up-sampled features 635 are processed using final neural network layer 645 to produce output features 650. In some cases, output features 650 have the same resolution as the initial resolution and the same number of channels as the initial number of channels.

According to some aspects, U-Net 600 receives additional input features to produce a conditionally generated output. In some cases, the additional input features include a vector representation of an input prompt. In some cases, the additional input features are combined with intermediate features 615 within U-Net 600 at one or more layers. For example, in some cases, a cross-attention module is used to combine the additional input features and intermediate features 615.

### Training an Image Generation Model

A method for image processing is described. One or more aspects of the method include obtaining a training set including a first image and a second image; encoding, using a first encoder, the first image to obtain a first encoder output; training an image generation model in a first stage based on the first encoder output; encoding, using a second encoder, the second image to obtain a second encoder output; and training the image generation model in the second stage based on the second encoder output. In some cases, obtaining a training set can include creating a custom training set or using a pre-existing training set for training the machine learning model.

In some aspects, the second encoder output has the same resolution as the first encoder output and more channels than the first encoder output. Some examples of the method, apparatus, and non-transitory computer readable medium further include adding parameters to the image generation model after the first stage, wherein the parameters are trained in the second stage.

In some aspects, the parameters are added to an input layer or an output layer of the image generation model. Some examples of the method, apparatus, and non-transitory computer readable medium further include encoding the second image comprises: encoding, using the first encoder, the second image to obtain an intermediate encoder output, wherein the second encoder output is based on the intermediate encoder output.

Some examples of the method, apparatus, and non-transitory computer readable medium further include encoding, using a third encoder, a third image to obtain a third encoder output. Some examples further include training the image generation model on a third stage based on the third encoder output. Some examples of the method, apparatus, and non-transitory computer readable medium further include training the first encoder based on a first decoder. Some examples further include training the second encoder based on the first encoder and a second decoder.

FIG. 7 shows an example of method for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system creates a training set including a first image and a second image. In some cases, the operations of this step refer to, or may be performed by, a training component as described with reference to FIG. 5. For example, at operation 705, the training set creation involves selecting two images with varying complexity. This step ensures the model learns to process different levels of image detail.

At operation 710, the system encodes, using a first encoder, the first image to obtain a first encoder output. In some cases, the operations of this step refer to, or may be performed by, an encoder as described with reference to FIG. 5. For example, at operation 710, encoding the first image with the first encoder involves capturing fundamental aspects, such as the basic shapes and colors in a landscape, focusing on primary elements like mountain outlines and dominant colors.

At operation 715, the system trains an image generation model in a first stage based on the first encoder output. In some cases, the operations of this step refer to, or may be performed by, a training component as described with reference to FIG. 5. For example, operation 715 uses the output from the first encoder, which could include training the model to recognize and differentiate primary landscape features such as the sky, land, and bodies of water.

At operation 720, the system encodes, using a second encoder, the second image to obtain a second encoder output. In some cases, the operations of this step refer to, or may be performed by, an encoder as described with reference to FIG. 5. For example, at operation 720, the second encoder processes an image with more complex details, like a cityscape, focusing on intricate textures and patterns, such as the detailed architecture of buildings.

At operation 725, the system trains the image generation model in the second stage based on the second encoder output. In some cases, the operations of this step refer to, or may be performed by, a training component as described with reference to FIG. 5. For example, operation 725 combines the outputs from both encoders in the feature embedding. This combined embedding is then used to enhance the model's capability in generating sophisticated images, leveraging the foundational understanding developed in the earlier stages.

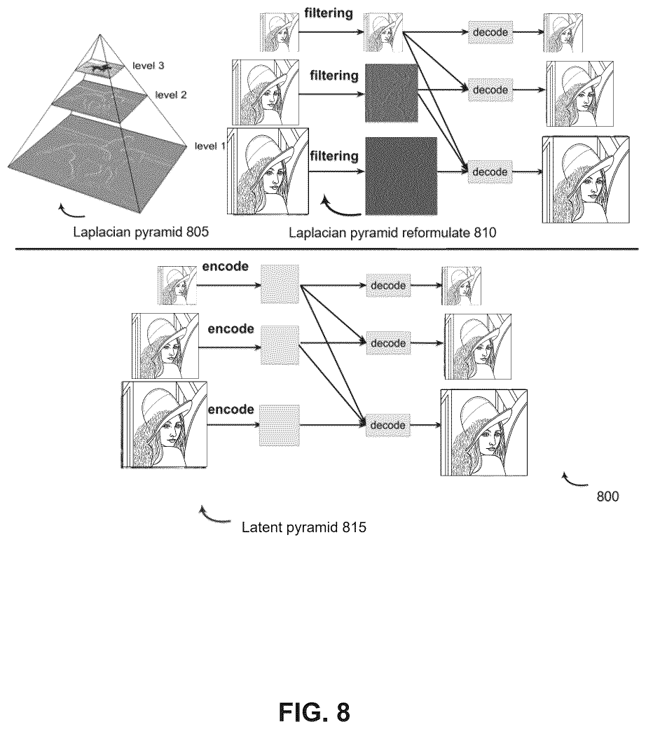

FIG. 8 shows an example of an example of training an image generation model according to aspects of the present disclosure. FIG. 8 is an example of, or includes aspects of, the corresponding element described with reference to FIGS. 2, 3, 6, and 9-12.

According to some embodiments, image data may be used to demonstrate the framework of the latent pyramid. In some cases, image data is used to exemplify the Latent Pyramid framework as Laplacian Pyramid modified within the realm of image data processing. The Laplacian Pyramid is a technique in image processing that constructs an image from multiple layers, starting from a low-resolution base and progressively adding details to enhance the image quality. The Latent Pyramid framework utilizes builds an image in a structured, layered manner, where each layer contributes to increasing the resolution and detail of the final image.

Referring to FIG. 8, Laplacian Pyramid 805 represents the initial stage of the framework, where the image data is processed starting from a low-resolution base. This stage establishes the foundational structure of the image in a manner similar to traditional Laplacian Pyramid methods in image processing.

Laplacian Pyramid Reformulate 810 involves the reformation of the traditional Laplacian Pyramid concept, adapting it within the Latent Pyramid framework. Laplacian Pyramid Reformulate 810 refers to a modified application of the traditional Laplacian Pyramid concept within the Latent Pyramid framework. The traditional Laplacian Pyramid is a technique used in image processing to decompose an image into multiple layers, each representing different levels of detail. The traditional Laplacian Pyramid allows for the reconstruction of an image from these layers, starting from a low-resolution base and progressively adding finer details. Laplacian Pyramid Reformulate 810 represents the process of enhancing the basic structure formed by the previous component with additional details and resolution.

Latent Pyramid 815 is a method or process within the Latent Pyramid framework that parallels the steps in a conventional Laplacian Pyramid, focusing on incrementally adding layers of detail to achieve a high-resolution and detailed final image. For example, an image is constructed starting from a low-resolution base, with subsequent levels adding more detail for enhanced quality. The framework aims to develop a series of encoders and decoders, denoted as {Eₖ: k=1, . . . , N} and {Dₖ: k=1, . . . , N}, respectively. Denotes the number of levels in the latent pyramid space. Once the latent pyramid is trained, we will need all the encoders {Eₖ: k=1, . . . , N} and the last decoder D_{N} for data encoding and decoding.

For example, training the image generation model involves training the encoders and decoders of the image generation model in multiple levels. At the first level of the Latent Pyramid framework, a downsized version of the data, I is utilized, and this version is referred to as L₁ constituting the foundational component of the latent space. This stage involves the use of the identity mapping function for both the encoder and decoder, which means that no actual training is required at this initial level. L₁ serves as the base upon which further details and resolution are added in subsequent levels of the pyramid.

At each subsequent level k in the Latent Pyramid framework, a new encoder Eₖ and decoder Dₖ are introduced. The encoder at this level processes a higher-resolution version of the data I, outputting a compact latent embedding map Lₖ. This map is then combined with the latent components from previous levels (L₁, L₂, . . . , Lₖ₋₁) and used as input for the new decoder. Both the encoder and decoder at each level are jointly trained to reconstruct the data, while encoders from earlier levels remain unchanged and are not involved in further training.

The process described in the Latent Pyramid framework involves repeating the second-level steps until reaching the final level, denoted as N. For example, the framework is a two-level pyramid (N=2). In some cases, although this framework requires minimal alterations to a standard Variational Autoencoder (VAE), it still leads to significant improvements in training latent generative models. For example, according to embodiments of the present disclosure a comparison between models trained on a standard 4-channel VAE and a 2-level 11-channel Latent Pyramid VAE demonstrates notable enhancements with the latter. Accordingly, the framework as illustrated in FIG. 8 allows for flexibility in training, permitting the use of different models and objective functions at each stage, like KL-VAE or VQ-VAE.

In some embodiments, in an example of a two-level Latent Pyramid VAE, the model is similar to a standard Variational Autoencoder (VAE), but with one or more additional modifications. For example, a downsized RGB input is incorporated at the bottleneck. In some cases, this modification represents a substantial enhancement to the vanilla VAE structure, allowing for more efficient training and improved handling of image data.

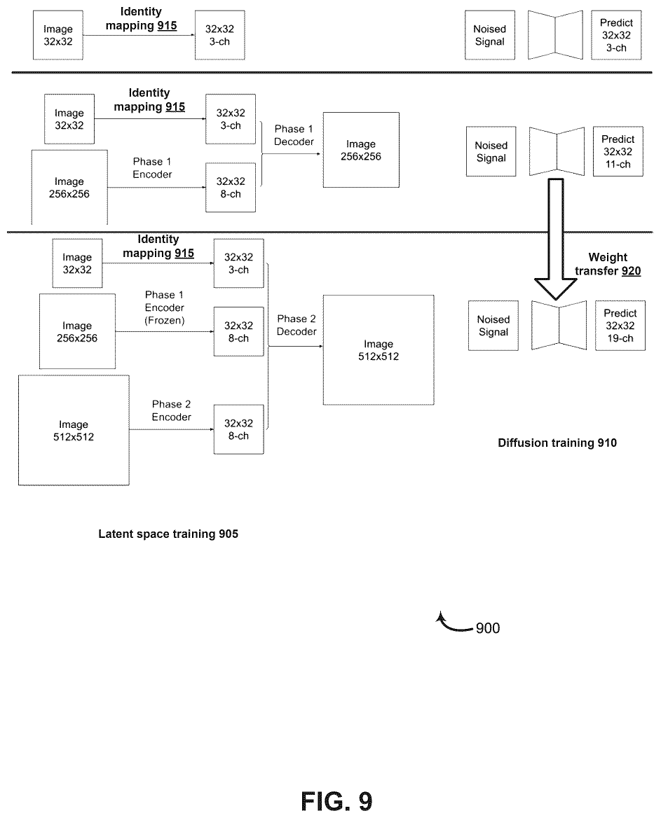

FIG. 9 shows an example of an example of training an image generation model according to aspects of the present disclosure. FIG. 9 is an example of, or includes aspects of, the corresponding element described with reference to FIGS. 2, 3, 6, 8, and 10-12.

According to some embodiments, the example of training an image generation model in FIG. 9 involves a paired progressive training of the Latent Pyramid Space and the generative model.

Referring to FIG. 9, a paired progressive training method 900 integrates the Latent Pyramid Space with a generative model.

In FIG. 9, the Latent Space Training 905 involves training encoders and decoders at multiple levels. Each stage progressively refines the training, with the initial phase focusing on a 32×32 input image through identity mapping. As the phases advance, higher-resolution images are processed, combining the outputs from various encoders to achieve greater detail and resolution in the synthetic images.

The process begins with an identity mapping of a 32×32 input image. This initial step sets the base for the pyramid structure. Subsequent to this, the model proceeds to handle two input images: one remains at 32×32, undergoing identity mapping, referred to as Identity Mapping 915, while the other image, at a resolution of 256×256, is processed through the encoder from the first phase. These two images are then combined and decoded to produce a 256×256 output image, enhancing the detail and resolution from the preceding step.

Subsequent to this, the model proceeds to take as input three input images of varying resolutions: 32×32, 256×256, and 512×512. The smallest image continues with the identity mapping, while the 256×256 image is processed by the previously trained (now frozen) encoder. The largest image, at 512×512, goes through the phase 2 encoder. The combined output from these processes is then decoded to generate a detailed 512×512 image.

The Diffusion Training 910 involves Weight Transfer 920 from one stage to the next. This transfer ensures that the gains and learnings from one stage are effectively utilized in subsequent stages, thereby enhancing the overall training efficiency and the quality of the generated images.

In some examples, each stage of training in the Latent Pyramid Space may provide a refinement to a latent generative model from the previous stage, adapting it to new latent space components. Diverse generative models can be employed at different stages. For instance, an initial stage might use an auto-regressive model, followed by a diffusion model in a subsequent stage, with the decoder reconstructing the image from combined stage outputs.

In some examples, this framework extends to other domains like video, where spatial downsampling is adapted to spatial-temporal downsampling. In some examples, this framework extends to multi-modal data, leveraging correlations between different modalities for enhanced compression.

FIG. 10 shows an example of a computing device 1000 according to aspects of the present disclosure. computing device 1000 includes processor(s) 1005, memory subsystem 1010, communication interface 1015, I/O interface 1020, user interface component(s) 1025, and channel 1030.

In some embodiments, computing device 1000 is an example of, or includes aspects of, the image generation apparatus described with reference to FIGS. 1 and 5. In some embodiments, computing device 1000 includes one or more processors 1005 that can execute instructions stored in memory subsystem 1010 to generate synthetic images comprising a first attribute and a second attribute by providing a first attribute token to a first set layers of the image generation model during a first set of time-steps and providing a second attribute token to a second set of layers of the image generation model during a second set of time-steps

According to some aspects, computing device 1000 includes one or more processors 1005. Processor(s) 1005 are an example of, or includes aspects of, the processor unit as described with reference to FIG. 5. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1010 includes one or more memory devices. Memory subsystem 1010 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component 1025 enables a user to interact with computing device 1000. In some cases, user interface component 1025 includes an audio device, such as an external speaker system, an external display device such as a display screen, an input device (e.g., a remote-control device interfaced with a user interface directly or through the I/O controller), or a combination thereof. In some cases, user interface component 1025 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt;
generating, using a generator of an image generation model, a feature embedding based on the text prompt, wherein the feature embedding includes a first set of channels that encodes a first value of an image characteristic and a second set of channels that encodes a residual between the first value of the image characteristic and a second value of the image characteristic; and
generating, using a decoder of the image generation model, a synthetic image corresponding to the second value of the image characteristic based on the feature embedding.

2. The method of claim 1, wherein:
the generator and the decoder of the image generation model are trained using a third encoder that outputs a third set of channels.

3. The method of claim 1, wherein generating the feature embedding comprises:
performing a reverse latent diffusion process.

4. The method of claim 1, wherein the first set of channels encodes a different modality from the second set of channels.

5. The method of claim 1, wherein:
the image characteristic comprises spatial resolution of the image, the first value of the image characteristic comprises a low spatial resolution, and the second value of the image characteristic comprises a high spatial resolution that is higher than the low spatial resolution.

6. The method of claim 1, wherein:
the synthetic image comprises a frame of a video, the image characteristic comprises temporal resolution of the video, the first value of the image characteristic comprises a low temporal resolution and the second value of the image characteristic comprises a high temporal resolution that is higher than the low temporal resolution.

7. The method of claim 1, wherein:
the image generation model is trained in a first stage using a first encoder and a second stage using the first encoder and a second encoder.

8. The method of claim 1, wherein:
the synthetic image includes an element from the text prompt based on the feature embedding.

9. A method for training an image generation model, comprising:
obtaining a training set including a first image and a second image;
encoding, using a first encoder, the first image to obtain a first encoder output;
training the image generation model in a first stage based on the first encoder output;
encoding, using a second encoder, the second image to obtain a second encoder output; and
training the image generation model in a second stage based on the second encoder output.

10. The method of claim 9, wherein the second encoder output has a same resolution as the first encoder output and more channels than the first encoder output.

11. The method of claim 9, further comprising:
adding parameters to the image generation model after the first stage, wherein the parameters are trained in the second stage.

12. The method of claim 11, wherein:
the parameters are added to an input layer or an output layer of the image generation model.

13. The method of claim 9, wherein encoding the second image comprises:
encoding, using the first encoder, the second image to obtain an intermediate encoder output, wherein the second encoder output is based on the intermediate encoder output.

14. The method of claim 9, further comprising:
encoding, using a third encoder, a third image to obtain a third encoder output; and
training the image generation model on a third stage based on the third encoder output.

15. The method of claim 9, further comprising:
training the first encoder based on a first decoder; and
training the second encoder based on the first encoder and a second decoder.

16. An apparatus comprising:
at least one processor;
at least one memory storing instruction executable by the at least one processor; and
an image generation model comprising instruction stored in the at least one memory and trained to generate a synthetic image, where the image generation model includes a generator and a decoder, wherein the generator is trained to generate a feature embedding based on a text prompt, wherein the feature embedding includes a first set of channels that encodes a first value of an image characteristic and a second set of channels that encodes a residual between the first value of the image characteristic and a second value of the image characteristic, wherein the decoder is trained to generate the synthetic image corresponding to a second image characteristic based on the feature embedding, and wherein the generator and the decoder are trained using a first encoder that outputs the first set of channels and a second encoder that outputs the second set of channels.

17. The apparatus of claim 16, wherein:
the generator comprises a latent diffusion model.

18. The apparatus of claim 16, wherein:
the decoder is trained using a variational autoencoder (VAE) model based on an output of the first encoder and the second encoder.

19. The apparatus of claim 18, wherein:
the decoder is trained using a VAE model based on an output of a third encoder that outputs a third set of channels.

20. The apparatus of claim 16, wherein:
the first encoder is trained using a VAE model based on an output of the first encoder that takes the first set of channels as input.
